(19) United States
(12) Patent Application Publication
(10) Pub. No.: US 2006/0181844 A1
(43) Pub. Date: Aug. 17, 2006

(54) Mouse storage device for a computer

(75) Inventors: Cheng-Pu Chu, Tucheng City (TW); Jung-Wen Chang, Lu Chu Hsiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Quanta Computer Inc.

(21) Appl. No.: 11/141,901

(22) Filed: Jun. 1, 2005

(30) Foreign Application Priority Data
Feb. 16, 2005 (TW) 94202594

(51) Int. Cl. G06F 1/16

(52) U.S. Cl. 361/683

(57) ABSTRACT

A mouse storage device for a computer comprises a hatch and a storage area. The storage area is located on a computer and comprises an open end and at least one elastic element. When the hatch is in an open position, a mouse stored therein is ejected from the storage area via elasticity produced by the elastic element. When the hatch is closed, the mouse can be stored in the storage area. A computer comprises a host and the mouse storage device as above.

### BACKGROUND

The present invention relates in general to a computer and in particular to a computer with a mouse storage devices.

Conventional mouse storage devices can be disposed in the back of monitors. This mechanism comprises a hatch and a storage area. The hatch opens and closes to provide access to the mouse. However, removal of the mouse can be inconvenient.

### SUMMARY

Accordingly, embodiments of the invention provide a mouse storage device comprising a hatch and a storage area. The storage area comprises an open end providing access for the mouse and at least one elastic element generating force to impel the mouse from the storage area.

### BRIEF DESCRIPTION OF THE DRAWINGS

The present invention can be more fully understood by reading the subsequent detailed description and examples with references made to the accompanying drawings, wherein:

FIG. 1 shows a mouse storage device of the present invention;

FIGS. 2a-2c show a computer mouse storage device containing a mouse.

### DETAILED DESCRIPTION

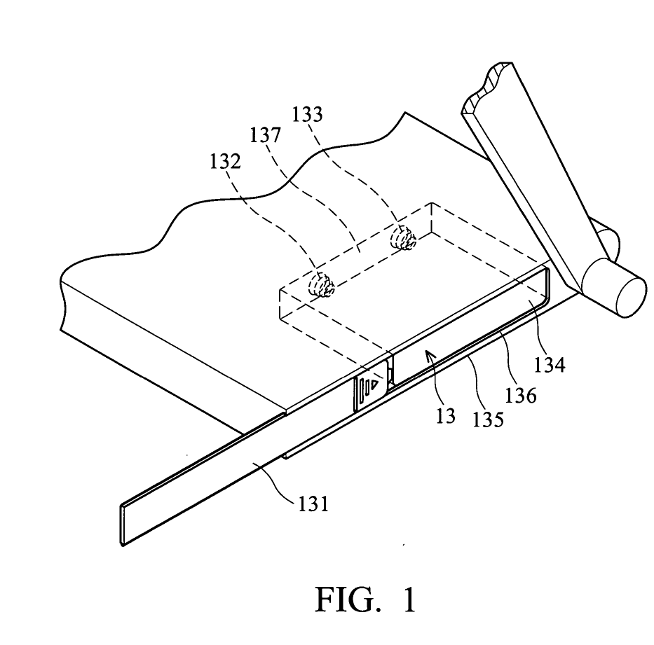

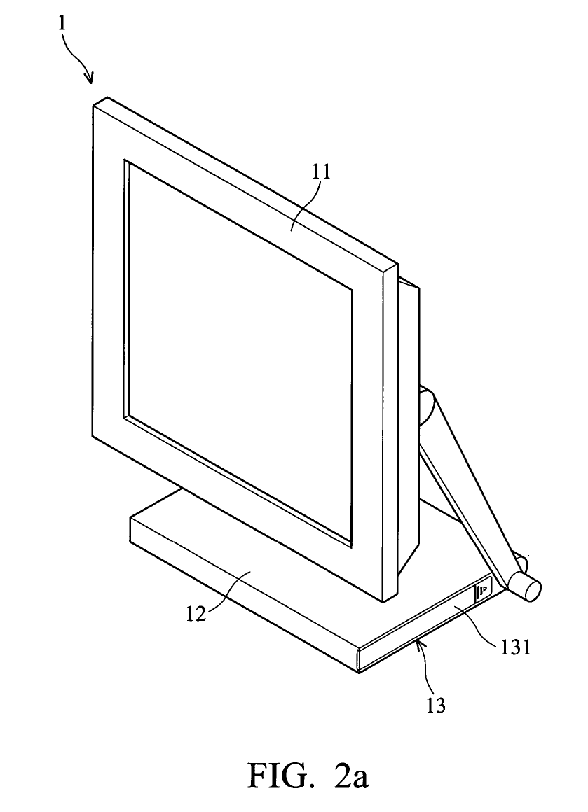

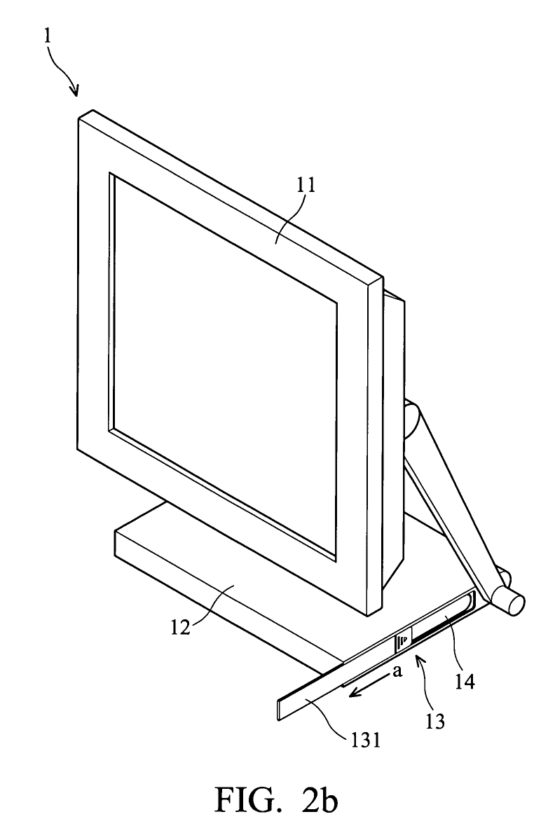

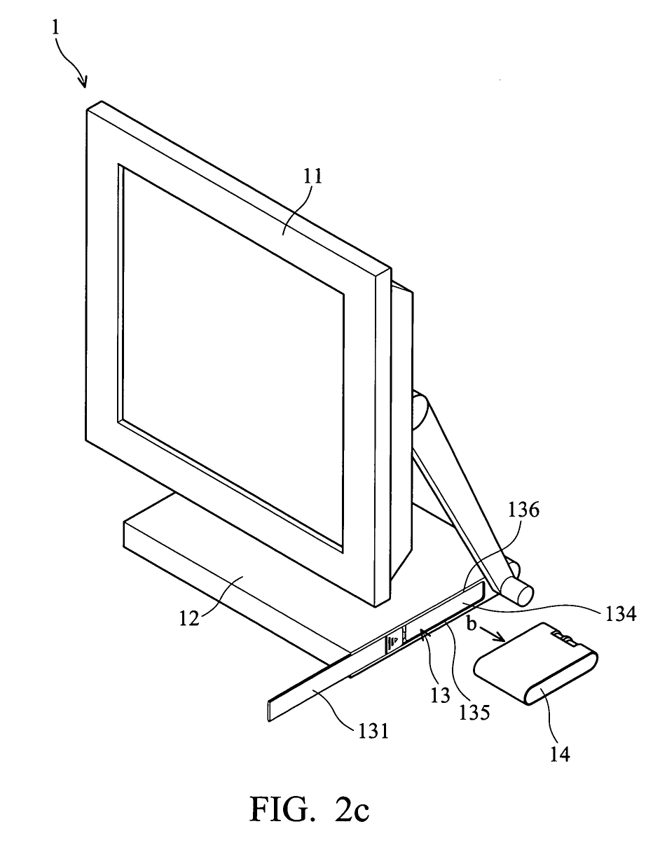

Referring to FIGS. 1 and 2a, a computer 1 comprises a monitor 11 and a host 12. The host 12 comprises a storage device 13 comprising a hatch 131 and a storage area 134. The storage area 134 comprises an open end 136, a closed end 137, two elastic elements 132, 133 and a track 135. The open end 136 provides access for mouse 14 (FIGS. 2b and 2c) e.g. a wireless mouse. The elastic elements 132, 133 are disposed at the closed end 137 opposite to the open end 136. The hatch 131 is slidably disposed on the track 135.

Referring to FIGS. 2a to 2c, the mouse 14 can be housed in the storage area 134 when not in use. When the mouse 14 is stored in the storage area 134, the hatch 131, in first position of the FIG. 2a, contains the mouse 14 inside the storage area 134. The mouse 14 in the storage area 134 experiences impelling force via the elastic elements 132, 133. The hatch 131 moves in direction (a) to allow removal of the mouse (FIG. 2b). When the hatch 131 moves to the second position, the elastic elements 132, 133 impel the mouse 14 in direction (b) as shown in FIG. 2c.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mouse storage device for a computer for receiving a mouse, comprising:
a hatch; and
a storage area disposed on the computer comprising:
an open end alternatively covered and uncovered by the hatch; and
at least one elastic element disposed in the storage area, generating elastic force, wherein the mouse is fixed between the elastic element and the hatch firmly.

2. The mouse storage device as claimed in claim 1, wherein the storage area further comprises a track on which the hatch is slidably disposed.

3. The mouse storage device as claimed in claim 1, wherein the storage area further comprises a closed end opposite to the open end, with the elastic element disposed therein.

4. A computer comprising:
a host; and
a mouse storage device as claimed in claim 1, disposed on the host.

5. The computer as claimed in claim 4, further comprising a wireless mouse, wherein the elastic element abuts against the wireless mouse when the wireless mouse is stored in the storage area.
